(19) United States
(12) Patent Application Publication
(10) Pub. No.: US 2025/0211599 A1
(43) Pub. Date: Jun. 26, 2025

(54) SYSTEMS AND METHODS FOR UTILIZING GRAPH NEURAL NETWORKS FOR SCAM WEBSITE DETECTION

(71) Applicant: GEN DIGITAL INC., TEMPE, AZ (US)

(72) Inventors: Acar Tamersoy, Culver City, CA (US); Kevin Alejandro Roundy, El Segundo, CA (US); Platon Kotzias, Athens (GR); Michalis Pachilakis, Dublin (IE); Iskander Sanchez Rola, Antibes (FR); Leylya Yumer, Antibes (FR)

(21) Appl. No.: 18/419,999

(22) Filed: Jan. 23, 2024

(30) Foreign Application Priority Data
Dec. 22, 2023 (EP) 23386139.2

(51) Int. Cl. H04L 9/40

(52) U.S. Cl. CPC H04L 63/1416; H04L 63/1483

(57) ABSTRACT

A computer-implemented method for utilizing graph neural networks for scam website detection may include (i) creating a dataset of target websites including unknown websites and known scam websites with corresponding scam categories, (ii) extracting website constructs utilized for executing scam attacks from the dataset of target websites, (iii) building a graph including nodes for associating each of the target websites with one or more of the corresponding scam categories, (iv) grouping, for each of the nodes, the target websites based on sharing a common construct within the website constructs, and (v) performing a security action that trains a graph neural network for identifying the unknown websites as potential scam websites based on a similarity score determined from the website constructs. Various other methods, systems, and computer-readable media are also disclosed.

### CROSS REFERENCE TO RELATED APPLICATION

This application claims the benefit of European Patent Application No. EP23386139.2, filed Dec. 22, 2023. The disclosure of this application is hereby incorporated, by reference, in its entirety.

### BACKGROUND

Traditional approaches for detecting scam websites may often include utilizing machine-learning algorithms that incorporate domain name system (DNS) or content-based features focusing on various hypertext markup language (HTML) characteristics associated with (known) scam web pages. These approaches however, are often based on the generalized assumption that unseen/future scam websites will contain the same characteristics as previously identified scam websites. Moreover, the machine-learning algorithms utilized by these approaches rely on fixed models such that model retraining would be needed to add or remove features. Due to the unlikelihood of attack vectors utilized by scam websites remaining unchanged over time, the effectiveness of the machine-learning algorithms utilized by these traditional approaches may often be ineffective and/or suboptimal at detecting new or unknown scam websites.

### SUMMARY

As will be described in greater detail below, the present disclosure describes various systems and methods for utilizing graph neural networks for scam website detection.

In one example, a method for utilizing graph neural networks for scam website detection may include (i) creating, by one or more computing devices, a dataset of target websites including unknown websites and known scam websites with corresponding scam categories, (ii) extracting, by the one or more computing devices, website constructs utilized for executing scam attacks from the dataset of target websites, (iii) building, by the one or more computing devices, a graph including nodes for associating each of the target websites with one or more of the corresponding scam categories, (iv) grouping, by the one or more computing devices and for each of the nodes, the target websites based on sharing a common construct within the website constructs, and (v) performing, by the one or more computing devices, a security action that trains a graph neural network (GNN) for identifying the unknown websites as potential scam websites based on a similarity score determined from the website constructs.

In some examples, the dataset of target websites may be created by (i) retrieving scam data identifying the known scam websites and the corresponding scam categories from one or more data sources and (ii) detecting, from the data sources, the unknown websites. In some examples, the scam data may be retrieved by querying the data sources for at least two of: telemetry data, malicious universal resource locator (URL) feeds, public website scam reports, and scam forum threads.

In some examples, the website constructs may be extracted by retrieving text data, image data, hypertext markup language (HTML) structure data, web analytics identifier data, online payment processor account data, or cryptographic key data. Additional website constructs may include cryptographic key data, company data, hosting infrastructure data, cookies and local storage data, cookie consent notice data, and network request log data.

In some examples, building the graph may include (i) assigning a first set of nodes corresponding to the target websites including the unknown websites and known scam websites, (ii) assigning a second set of nodes corresponding to each of the scam categories, (iii) assigning a third set of nodes corresponding to each of the website constructs, and (iv) utilizing a set of edges that joins the first set of nodes with the second set of nodes and the first set of nodes with the third set of nodes. In some examples, the target websites may be grouped by clustering a set of the nodes sharing the common construct. In one example, a longest common substring may be utilized for each of the website constructs to identify the common construct for the grouping. In another example, perceptual hashing may be utilized for each of the website constructs to identify the common construct for the grouping.

In some examples, the security action that trains the GNN (which may be an inductive GNN) for identifying the unknown websites as potential scam websites based on the similarity score determined from the website constructs may include (i) capturing structural information embedded in the graph to detect similarities between the unknown websites and the known scam websites and (ii) determining the similarity score based on the detected similarities.

In one embodiment, a system for utilizing graph neural networks for scam website detection may include at least one physical processor and physical memory that includes computer-executable instructions and a set of modules that, when executed by the physical processor, cause the physical processor to that, when executed by the physical processor, cause the physical processor to (i) create, by a dataset module, a dataset of target websites including unknown websites and known scam websites with corresponding scam categories, (ii) extract, by a construct module, website constructs utilized for executing scam attacks from the dataset of target websites, (iii) build, by a graph module, a graph including nodes for associating each of the target websites with one or more of the corresponding scam categories, (iv) group, by a grouping module and for each of the nodes, the target websites based on sharing a common construct within the website constructs, and (v) perform, by a security module, a security action that trains a GNN for identifying the unknown websites as potential scam websites based on a similarity score determined from the website constructs.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) create a dataset of target websites including unknown websites and known scam websites with corresponding scam categories, (ii) extract website constructs utilized for executing scam attacks from the dataset of target websites, (iii) build a graph including nodes for associating each of the target websites with one or more of the corresponding scam categories, (iv) group, for each of the nodes, the target websites based on sharing a common construct within the website constructs, and (v) perform a security action that trains a GNN for identifying the unknown websites as potential scam websites based on a similarity score determined from the website constructs.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for utilizing graph neural networks for scam website detection.

FIG. 2 is a block diagram of an additional example system for utilizing graph neural networks for scam website detection.

FIG. 3 is a flow diagram of an example method for utilizing graph neural networks for scam website detection.

FIG. 4 is a block diagram of a graph that may be utilized by the example systems of FIGS. 1 and 2.

FIG. 5 is a block diagram of a GNN output predicting probabilities of an unknown website belonging to a scam website category.

FIG. 6 is a block diagram of an example computing system capable of implementing one or more of the embodiments described and/or illustrated herein.

FIG. 7 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to systems and methods for utilizing graph neural networks for scam website detection. As will be described in greater detail below, the systems and methods described herein may discover and categorize new scam websites by encoding key relationships between websites and their constructs (i.e., reused website elements such as text, images, cookies, etc.) as nodes in a heterogeneous graph. The graph may include (i) nodes corresponding to known scam and unknown websites, (ii) nodes indicating various scam categories/types (e.g., technical support scams, pet scams, advance-fee scams, etc.), and (iii) nodes for the website constructs. The graph may additionally include edges that capture the relationships between these node types (e.g., if a website contains a construct, there will be an edge between their respective nodes). Additionally, the systems and methods described herein may include performing graph preprocessing by clustering nodes corresponding to similar constructs (i.e., super-nodes) utilizing min-cut partitioning, so as to improve graph scalability. The systems and methods described herein may then perform scam website detection over the graph by training an inductive GNN that performs edge prediction to determine the likelihood that an edge between an unknown website node and a scam type node, which will identify the unknown website as a scam website of a particular scam/category type. By training the GNN in this way, the systems and methods described herein may perform website scam detection without model retraining. Additionally, the systems and methods described herein may improve the technical field of data privacy by identifying previously unidentified scam websites, thereby protecting against the unintentional disclosure of sensitive data by visitors engaged in browsing these websites.

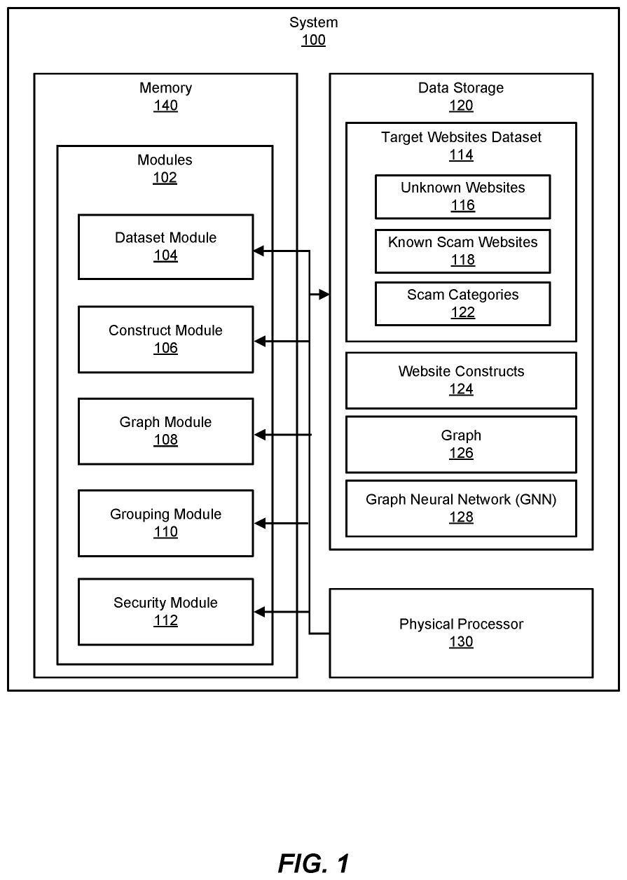

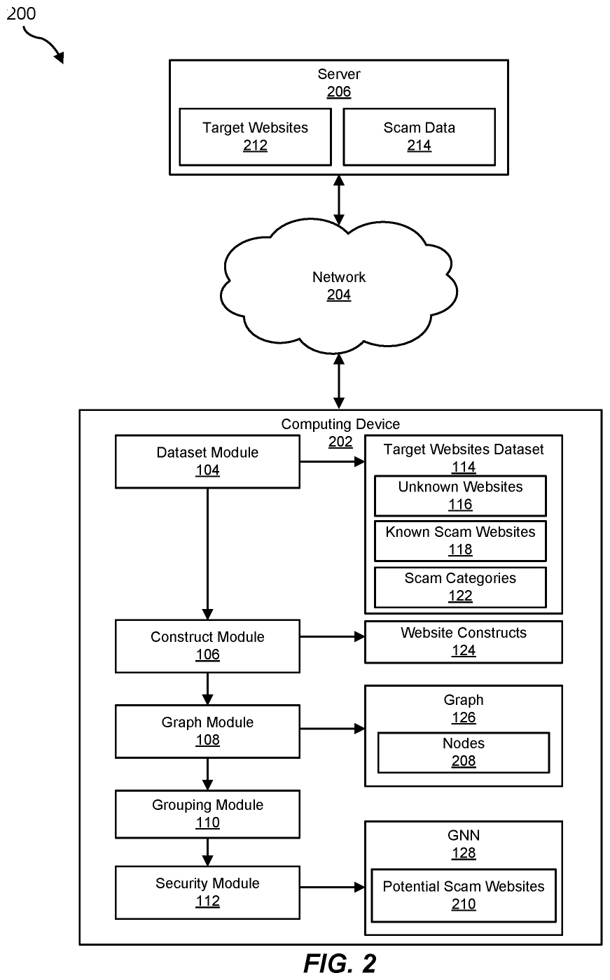

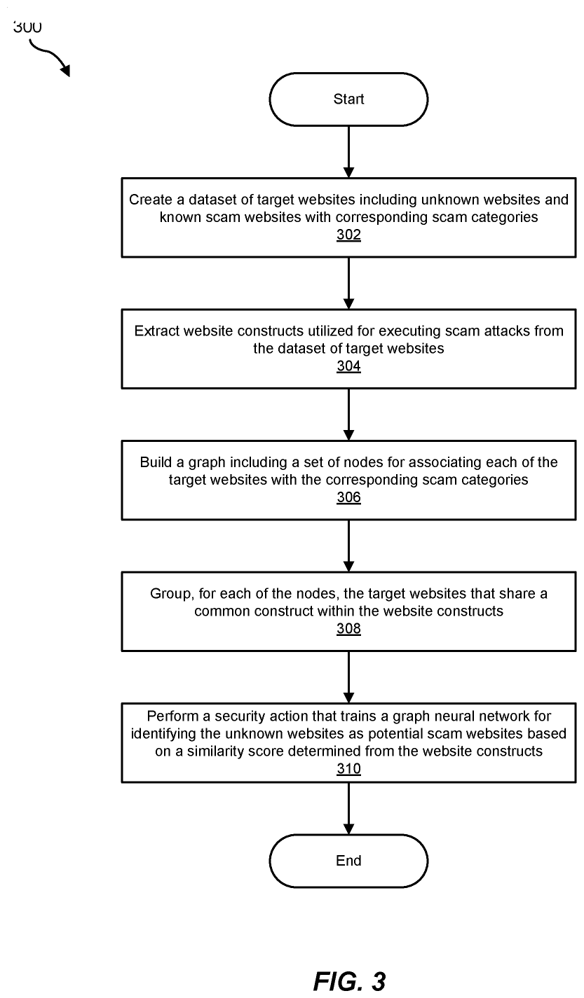

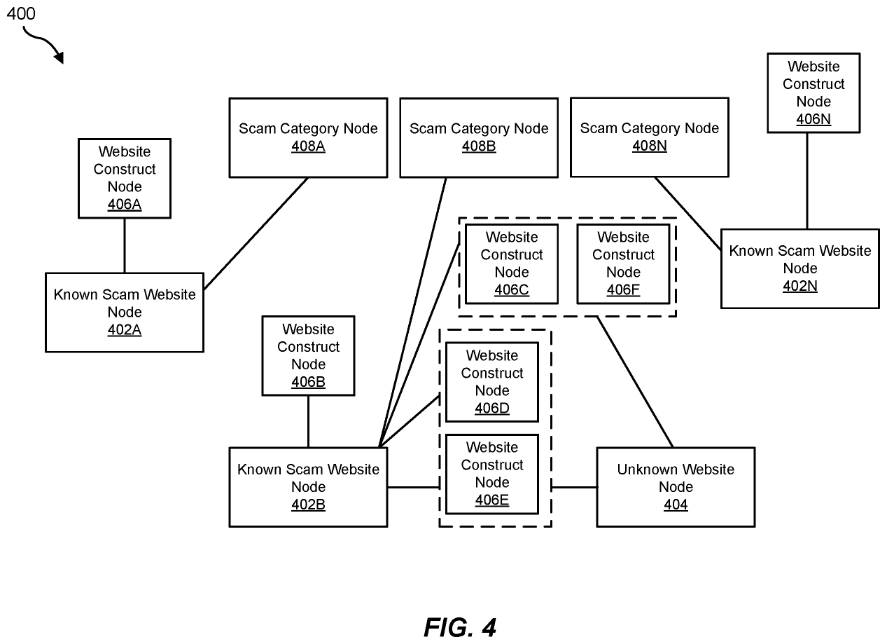

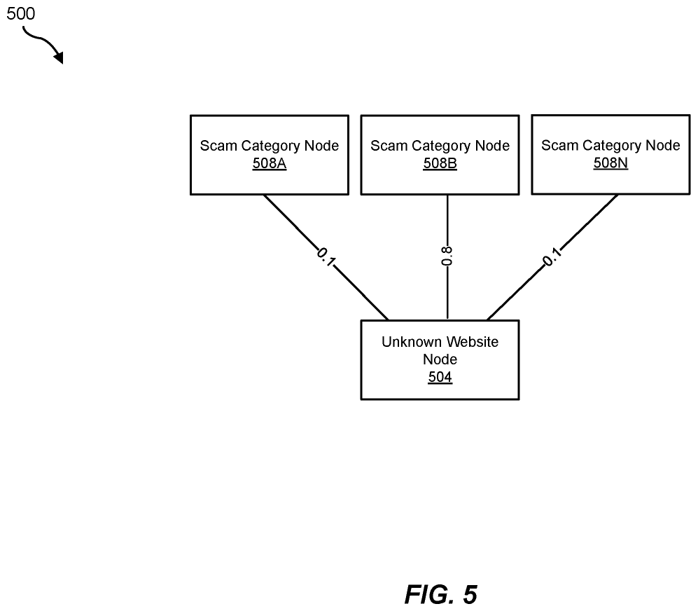

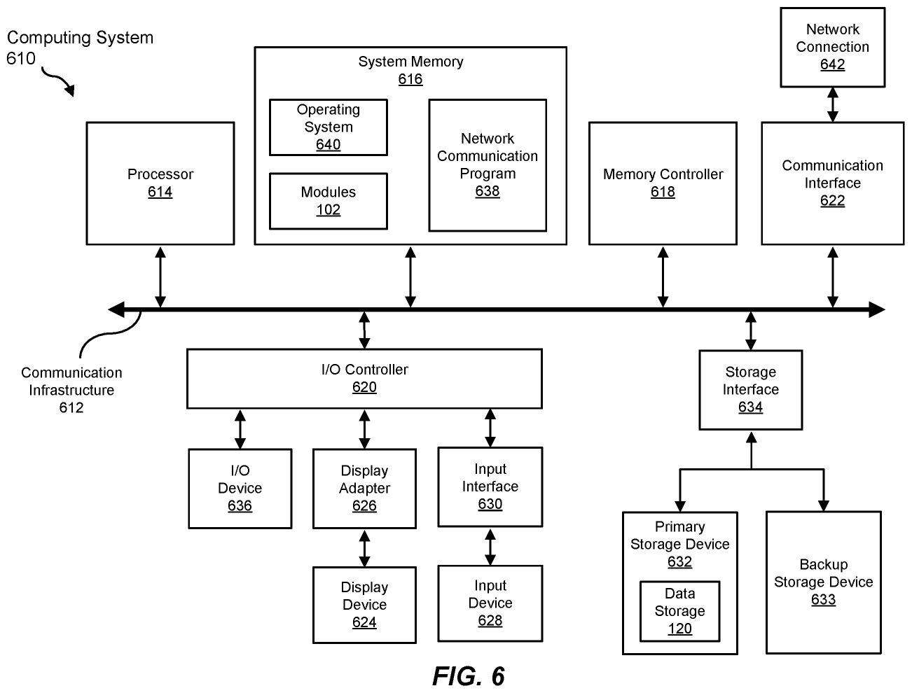

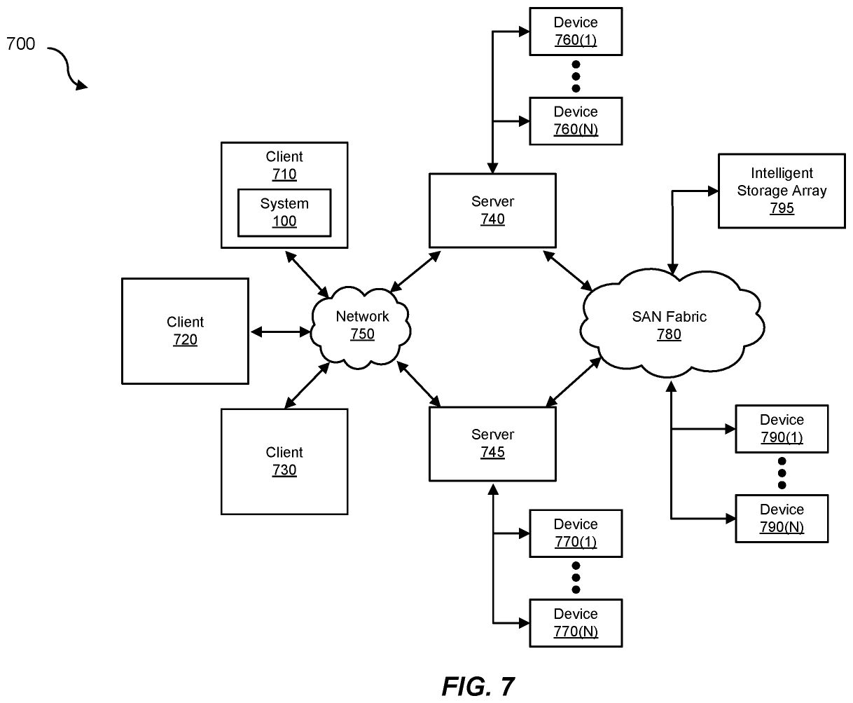

The following will provide, with reference to FIGS. 1-2, detailed descriptions of example systems for utilizing graph neural networks for scam website detection. Detailed descriptions of corresponding computer-implemented methods will also be provided in connection with FIG. 3. In addition, a detailed description of a graph that may be utilized by the example systems of FIGS. 1 and 2 will also be provided in connection with FIG. 4. In addition, a detailed description of a GNN output predicting probabilities of an unknown website belonging to a scam website category, will also be provided in connection with FIG. 5. In addition, detailed descriptions of an example computing system and network architecture capable of implementing one or more of the embodiments described herein will be provided in connection with FIGS. 6 and 7, respectively.

FIG. 1 is a block diagram of an example system 100 for utilizing graph neural networks for scam website detection. As illustrated in this figure, example system 100 may include one or more modules 102 for performing one or more tasks. For example, and as will be explained in greater detail below, example system 100 may include a dataset module 104 that creates target websites dataset 114 including unknown websites 116 and known scam websites 118 with corresponding scam categories 122. Example system 100 may additionally include a construct module 106 that extracts website constructs 124 utilized for executing scam attacks from target websites dataset 114. Example system 100 may also include a graph module 108 that builds a graph 126. As will be described in greater detail below, graph 126 may include a group of nodes for associating target websites with corresponding scam categories 122. Example system 100 may additionally include a grouping module 110 that groups, for each of the nodes in the graph, target websites sharing a common construct within website constructs 124. Example system 100 may also include a security module 112 that performs a security action that trains a graph neural network (GNN) 128 (hereinafter referred to as GNN 128) for identifying unknown websites 116 as potential scam websites based on a similarity score determined from website constructs 124. Although illustrated as separate elements, one or more of modules 102 in FIG. 1 may represent portions of a single module or application.

The term “target websites” as used herein, may generally refer a collection of known scam websites, associated scam website data (e.g., scam categories), and unknown websites for identifying new/unknown scams associated with the unknown websites.

The term “website constructs” as used herein, may generally refer to any number of reused website elements (e.g., components, code, and/or resources) utilized by scam operators for generating new scam websites. In some examples, these website elements may include, without limitation, textual content (e.g., text surrounded by HTML tags in website HTML code), images (e.g., images referenced HTML image tags in HTML code), HTML structure (e.g., frequently used HTML tags), website analytics identifiers, online payment processor accounts (e.g., merchant account names), cryptographic keys in TLS certificates, company information (e.g., name, mailing address, e-mail address, social media handles, etc.), hosting infrastructure (e.g., website hosting components and services), cookies and localStorage (e.g., for persisting browser sessions), cookie consent notices, and/or network request logs (e.g., website initiated browser requests for data from external sources).

The term “GNN” as used herein, may generally refer to a neural network utilizing representation machine-learning algorithms in which the objective is to learn representations (or features) of data thereby facilitating the extraction of patterns when building classifiers. An example of the aforementioned neural network may include an inductive GNN. In some examples, an inductive GNN may be trained to generalize unseen nodes and enabling the adding or removal of nodes to/from a graph at any point and perform detection without model retraining (under certain conditions).

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate utilizing graph neural networks for scam website detection. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, example system 100 may also include a data storage 120 for storing data. In one example, data storage 120 may store target websites dataset 114 (including unknown websites 116, known scam websites 118, and scam categories 122), website constructs 124, graph 126, and GNN 128.

Example system 100 in FIG. 1 may be implemented in a variety of ways. For example, all or a portion of example system 100 may represent portions of example system 200 in FIG. 2. As shown in FIG. 2, system 200 may include a computing device 202 in communication with server 206 (for target websites 212 and scam data 214) via a network 204. In one example, all or a portion of the functionality of modules 102 may be performed by computing device 202, server 206 and/or any other suitable computing system. As will be described in greater detail below, one or more of modules 102 from FIG. 1 may, when executed by at least one processor of computing device 202, enable computing device 202 to utilize graph neural networks for scam website detection. For example, and as will be described in greater detail below, dataset module 104, construct module 106, graph module 108, grouping module 110, and security module 112, may cause computing device 202 to (i) create target websites dataset 114 including unknown websites 116 and known scam websites 118 with corresponding scam categories 122, (ii) extract website constructs 124 utilized for executing scam attacks from target websites dataset 114, (iii) guild graph 126 including nodes 208 for associating each of target websites 212 with corresponding scam categories 122, (iv) group, for each of nodes 208, target websites 212 sharing a common construct within website constructs 124, and (v) perform a security action that trains GNN 128 for identifying unknown websites 116 as potential scam websites 210 based on a similarity score determined from website constructs 124.

Computing device 202 generally represents any type or form of computing device capable of reading computer-executable instructions. In some examples, may represent an endpoint device running client-side security software configured to identify malicious websites including performing scam website detection. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Server 206 generally represents any type or form of computing device that is capable of executing and/or reading computer-executable instructions. In some examples, server 206 may be a backend data server configured to store website and database data describing previously identified scam activities. Additional examples of server 206 include, without limitation, security servers, application servers, web servers, storage servers, and/or database servers configured to run certain software applications and/or provide various security, web, storage, and/or database services. Although illustrated as a single entity in FIG. 2, server 206 may include and/or represent a plurality of servers that work and/or operate in conjunction with one another.

Network 204 generally represents any medium or architecture capable of facilitating communication or data transfer. In one example, network 204 may facilitate communication between computing device 202 and server 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for utilizing graph neural networks for scam website detection. The steps shown in FIG. 3 may be performed by any suitable computer-executable code and/or computing system, including system 100 in FIG. 1, system 200 in FIG. 2, and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 302 one or more of the systems described herein may create a dataset of target websites including unknown websites and known scam websites with corresponding scam categories. For example, dataset module 104 may, as part of computing device 202, create target websites dataset 114 including unknown websites 116, known scam websites 118, and scam categories 122 corresponding to known scam websites 118.

Dataset module 104 may create target websites dataset 114 in a variety of ways. In some examples, dataset module 104 may retrieve scam data 214 identifying known scam websites 118 and corresponding scam categories 122 (e.g., technical support scams, pet scams, advance-fee scams, etc.) from server 206 (i.e., a data source). Additionally, dataset module 104 may also detect unknown websites 116 (e.g., previously unidentified or new websites) in target websites 212 from server 206. In some examples, dataset module 104 may retrieve scam data 214 by querying server 206 for telemetry data (e.g., internal scam telemetry generated by security software), malicious URL feeds, public website scam reports, and/or online forum threads dedicated to identifying website scams.

At step 304, one or more of the systems described herein may extract website constructs utilized for executing scam attacks from the dataset of target websites. For example, construct module 106 may, as part of computing device 202 in FIG. 2, extract website constructs 124 from target websites dataset 114 (i.e., from known scam websites 118 and unknown websites 116).

Construct module 106 may extract website constructs 124 in a variety of ways. In some examples, construct module 106 may retrieve any or a combination of the following website elements: textual content (e.g., text surrounded by HTML tags in website HTML code), images (e.g., images referenced HTML image tags in HTML code), HTML structure (e.g., frequently used HTML tags), website analytics identifiers, online payment processor accounts (e.g., merchant account names), cryptographic keys in TLS certificates, company information (e.g., name, mailing address, e-mail address, social media handles, etc.), hosting infrastructure (e.g., website hosting components and services), cookies and localStorage (e.g., for persisting browser sessions), cookie consent notices, and network request logs (e.g., website initiated browser requests for data from external sources). In some examples, other website elements not specifically identified herein, may also be retrieved as website constructs 124 from target websites dataset 114.

At step 306, one or more of the systems described herein may build a graph including a set of nodes for associating each of the target websites with the corresponding scam categories. For example, graph module 108 may, as part of computing device 202 in FIG. 2, build graph 126, including nodes 208, for associating each of target websites 212 (e.g., unknown websites 116 and known scam websites 118) with scam categories 122.

Graph module 108 may build graph 126 in a variety of ways which will now be described with respect to FIG. 4. Referring now to FIG. 4, an example graph 400, which may be constructed by graph module 108, is shown. In some examples, graph 400 may represent a heterogeneous graph “G” in a mathematical expression where is it is assumed that G=({V_w U V_t U V_c}, E) and where V_w represents a set of nodes corresponding to known scam websites and unknown scam websites (e.g., known scam website nodes 402A, 402B, and 402N and unknown website node 404), V_t represents various scam categories/types (e.g., scam category nodes 408A, 408B, and 408N), and where V_c represents website constructs (e.g., website construct nodes 406A, 406B, 406C, 406D, 406E, 406F, and 406N). Additionally, E represents a set of edges connecting of a pair of graph nodes (e.g., the lines connecting pairs of nodes in the group including nodes 402A-402N, 406A-406N, and 408A-408N in graph 400). For example, for a website containing a specific image, there will be an edge in the graph G between nodes corresponding to the website (in V_w) and the image (in V_c). Similarly, if a website is known to be associated with a particular scam category/type, there will be an edge in the graph G between the nodes corresponding to the website (in V_w) and the node representing the scam category/type (in V_t).

Returning now to FIG. 3, at step 308, one or more of the systems described herein may group, for each of the nodes, the target websites that share a common construct within the website constructs. For example, grouping module 110 may, as part of computing device 202 in FIG. 2, group the nodes for target websites 212 in graph 126 that share a common website construct 124.

Grouping module 110 may group the nodes for target websites 212 in a variety of ways. In some examples, grouping module 110 may cluster sets of nodes in graph 126 that share a common website construct 124. In one example, grouping module 110 may be configured to cluster the set of nodes in graph 126 by utilizing a longest common substring for each of website constructs 124 to identify the common construct for the grouping. Additionally or alternatively, grouping module 110 may be configured to cluster the set of nodes in graph 26 by utilizing perceptual hashing for each of website constructs 124 to identify the common construct for the grouping.

For example, and as shown in FIG. 4, both known scam website node 402B and unknown website node 404 share common website constructs represented by a group including website construct nodes 406D, 406E and a group including website construct nodes 406C and 406F. In this example, website construct node 406E may represent a shared image (e.g., a pet image) commonly utilized in pet scams, in a website construct for a known scam website (represented by known scam website node 402B) and an unknown website (represented by unknown website node 404). Similarly, website construct nodes 406C and 406E may represent similar text excerpts (e.g., “I only ask for the cost of transportation” and “I only ask for the cost of vaccination”) that may be commonly utilized for requesting money in pet scams, in a website construct for a known scam website (represented by known scam website node 402B) and an unknown website (represented by unknown website node 404).

At step 310, one or more of the systems described herein may perform a security action that trains a GNN for identifying the unknown websites as potential scam websites based on a similarity score determined from the website constructs. For example, security module 112 may, as part of computing device 202 in FIG. 2, train GNN 128 for identifying unknown websites 116 as potential scam websites 210 based on a similarity score determine from website constructs 124.

Security module 112 may train GNN 128 in a variety of ways. In some examples, security module 112 may train an inductive GNN over graph 126 to predict the probability of missing edges by capturing structural information (i.e., website constructs 124) embedded as nodes. By training an inductive GNN in this way, security module 112 may determine that scam websites sharing many website constructs 124 are likely to belong to the same scam category/type (e.g., a same category 122) and that their nodes should have strong structural similarities to one another in graph 126. For example, GNN 128 may be configured to compute the likelihood that there is an edge in graph 126 signifying similarities between nodes representing unknown websites 116 and nodes representing scam categories 122 and thereby denoting a confidence level (i.e., a similarity score) that an unknown website 116 is a scam website of a particular type/scam category 122.

Turning now to FIG. 5, an example output 500 of GNN 128 showing scores based on similarities between unknown website node 504 and scam category nodes 508A, 508B, and 508N. As shown in FIG. 5, unknown website node 504 has a 0.8 similarity score with scam category node 508B indicating a high probability (e.g., based on a scale between 0 and 1) that an unknown website 116 is a scam website (e.g., a potential scam website 210). Conversely, unknown website node 504 has a 0.1 similarity score with scam category nodes 508A and 508N, indicating a low probability (e.g., based on a scale between 0 and 1) that an unknown website 116 is not a scam website with respect to scam categories 122 associated with these nodes. In some examples, scam websites detected by training GNN 128 may be ranked from which potential scam websites 210 associated with a top set of similarity scores (e.g., scores higher than 0.6 on a scale between 0 and 1) may be immediately identified as scam websites and pushed to security software for updating a scam website database, while any remaining potential scam websites 210 (e.g., scores that are about 0.5 on a scale between 0 and 1) may be inspected by secondary scam website technologies.

As explained above in connection with example method 300 in FIG. 3, the systems and methods described herein may discover and categorize new scam websites by encoding key relationships between websites and their constructs (i.e., reused website elements such as text, images, cookies, etc.) as nodes in a heterogeneous graph. The graph may include (i) nodes corresponding to known scam and unknown websites, (ii) nodes indicating various scam categories/types (e.g., technical support scams, pet scams, advance-fee scams, etc.), and (iii) nodes for the website constructs. The graph may additionally include edges that capture the relationships between these node types (e.g., if a website contains a construct, there will be an edge between their respective nodes). Additionally, the systems and methods described herein may include performing graph preprocessing by clustering nodes corresponding to similar constructs (i.e., super-nodes) utilizing min-cut partitioning, so as to improve graph scalability. The systems and methods described herein may then perform scam website detection over the graph by training an inductive GNN that performs edge prediction to determine the likelihood that an edge between an unknown website node and a scam type node, which will identify the unknown website as a scam website of a particular scam/category type. By training the GNN in this way, the systems and methods described herein may perform website scam detection without model retraining.

FIG. 6 is a block diagram of an example computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 3). All or a portion of computing system 610 may also perform and/or be a means for performing any other steps, methods, or processes described and/or illustrated herein.

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the example embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In some examples, system memory 616 may store and/or load an operating system 640 for execution by processor 614. In one example, operating system 640 may include and/or represent software that manages computer hardware and software resources and/or provides common services to computer programs and/or applications on computing system 610. Examples of operating system 640 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

As illustrated in FIG. 6, computing system 610 may also include at least one display device 624 coupled to I/O controller 620 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, example computing system 610 may also include at least one input device 628 coupled to I/O controller 620 via an input interface 630. Input device 628 generally represents any type or form of input device capable of providing input, either computer or human generated, to example computing system 610. Examples of input device 628 include, without limitation, a keyboard, a pointing device, a speech recognition device, variations or combinations of one or more of the same, and/or any other input device.

Additionally or alternatively, example computing system 610 may include additional I/O devices. For example, example computing system 610 may include I/O device 636. In this example, I/O device 636 may include and/or represent a user interface that facilitates human interaction with computing system 610. Examples of I/O device 636 include, without limitation, a computer mouse, a keyboard, a monitor, a printer, a modem, a camera, a scanner, a microphone, a touchscreen device, variations or combinations of one or more of the same, and/or any other I/O device.

Communication interface 622 broadly represents any type or form of communication device or adapter capable of facilitating communication between example computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

In some examples, system memory 616 may store and/or load a network communication program 638 for execution by processor 614. In one example, network communication program 638 may include and/or represent software that enables computing system 610 to establish a network connection 642 with another computing system (not illustrated in FIG. 6) and/or communicate with the other computing system by way of communication interface 622. In this example, network communication program 638 may direct the flow of outgoing traffic that is sent to the other computing system via network connection 642. Additionally or alternatively, network communication program 638 may direct the processing of incoming traffic that is received from the other computing system via network connection 642 in connection with processor 614.

Although not illustrated in this way in FIG. 6, network communication program 638 may alternatively be stored and/or loaded in communication interface 622. For example, network communication program 638 may include and/or represent at least a portion of software and/or firmware that is executed by a processor and/or Application Specific Integrated Circuit (ASIC) incorporated in communication interface 622.

As illustrated in FIG. 6, example computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610. In one example, data storage 120 from FIG. 1 may be stored and/or loaded in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 610 may be configured as an Application Specific Integrated Circuit (ASIC) adapted to implement one or more of the example embodiments disclosed herein.

FIG. 7 is a block diagram of an example network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 3). All or a portion of network architecture 700 may also be used to perform and/or be a means for performing other steps and features set forth in the present disclosure.

Client systems 710, 720, and 730 generally represent any type or form of computing device or system, such as example computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to example computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the example embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an example method for utilizing graph neural networks for scam website detection.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for utilizing graph neural networks for scam website detection, at least a portion of the method being performed by one or more computing devices comprising at least one processor, the method comprising:
creating, by the one or more computing devices, a dataset of target websites comprising unknown websites and known scam websites with corresponding scam categories;
extracting, by the one or more computing devices, a plurality of website constructs utilized for executing scam attacks from the dataset of target websites;
building, by the one or more computing devices, a graph comprising a plurality of nodes for associating each of the target websites with one or more of the corresponding scam categories;
grouping, by the one more computing devices and for each of the nodes, the target websites based on sharing a common construct within the plurality of website constructs; and
performing, by the one or more computing devices, a security action that trains a graph neural network (GNN) for identifying the unknown websites as potential scam websites based on a similarity score determined from the plurality of website constructs.

2. The computer-implemented method of claim 1, wherein creating the dataset of target websites comprises:
retrieving scam data identifying the known scam websites and the corresponding scam categories from one or more data sources; and
detecting, from the data sources, the unknown websites.

3. The computer-implemented method of claim 2, wherein retrieving the scam data comprises querying the data sources for at least two of:
telemetry data;
malicious universal resource locator (URL) feeds;
public website scam reports; and
scam forum threads.

4. The computer-implemented method of claim 1, wherein extracting the website constructs comprises retrieving, from the dataset of target websites, at least one of:
text data;
image data;
hypertext markup language (HTML) structure data;
web analytics identifier data;
online payment processor account data; or
cryptographic key data.

5. The computer-implemented method of claim 1, wherein building the graph comprises:
assigning a first set of nodes corresponding to the target websites comprising the unknown websites and known scam websites;
assigning a second set of nodes corresponding to each of the scam categories;
assigning a third set of nodes corresponding to each of the website constructs; and
utilizing a plurality of edges that joins the first set of nodes with the second set of nodes and the first set of nodes with the third set of nodes.

6. The computer-implemented method of claim 1, wherein grouping, for each of the nodes, the target websites based on sharing a common construct within the plurality of website constructs comprises clustering a set of the nodes sharing the common construct.

7. The computer-implemented method of claim 6, wherein clustering the set of the nodes sharing the common construct comprises utilizing a longest common substring for each of the plurality of website constructs to identify the common construct for the grouping.

8. The computer-implemented method of claim 6, wherein clustering the set of the nodes sharing the common construct comprises utilizing perceptual hashing for each of the plurality of website constructs to identify the common construct for the grouping.

9. The computer-implemented method of claim 1, wherein performing the security action that trains the GNN for identifying the unknown websites as potential scam websites based on the similarity score determined from the plurality of website constructs comprises:
capturing structural information embedded in the graph to detect similarities between the unknown websites and the known scam websites; and
determining the similarity score based on the detected similarities.

10. The computer-implemented method of claim 1, wherein comprises an inductive GNN.

11. A system for utilizing graph neural networks for scam website detection, the system comprising:
at least one physical processor;
physical memory comprising computer-executable instructions and one or more modules that, when executed by the physical processor, cause the physical processor to:
create, by a dataset module, a dataset of target websites comprising unknown websites and known scam websites with corresponding scam categories;
extract, by a construct module, a plurality of website constructs utilized for executing scam attacks from the dataset of target websites;
build, by a graph module, a graph comprising a plurality of nodes for associating each of the target websites with one or more of the corresponding scam categories;
group, by a grouping module and for each of the nodes, the target websites based on sharing a common construct within the plurality of website constructs; and
perform, by a security module, a security action that trains a graph neural network (GNN) for identifying the unknown websites as potential scam websites based on a similarity score determined from the plurality of website constructs.

12. The system of claim 11, wherein the dataset module creates the dataset of target websites by:
retrieving scam data identifying the known scam websites and the corresponding scam categories from one or more data sources; and
detecting, from the data sources, the unknown websites.

13. The system of claim 12, wherein the scam data is retrieved by querying the data sources for at least two of:
telemetry data;
malicious universal resource locator (URL) feeds;
public website scam reports; and
scam forum threads.

14. The system of claim 11, wherein the construct module extracts the website constructs by retrieving, from the dataset of target websites, at least one of:
text data;
image data;
hypertext markup language (HTML) structure data;
web analytics identifier data;
online payment processor account data; or
cryptographic key data.

15. The system of claim 11, wherein the graph module builds the graph by:
assigning a first set of nodes corresponding to the target websites comprising the unknown websites and known scam websites;
assigning a second set of nodes corresponding to each of the scam categories;
assigning a third set of nodes corresponding to each of the website constructs; and
utilizing a plurality of edges that joins the first set of nodes with the second set of nodes and the first set of nodes with the third set of nodes.

16. The system of claim 11, wherein the grouping module groups, for each of the nodes, the target websites based on sharing a common construct within the plurality of website constructs by clustering a set of the nodes sharing the common construct.

17. The system of claim 16, wherein the set of the nodes sharing the common construct are clustered by utilizing a longest common substring for each of the plurality of website constructs to identify the common construct for the grouping.

18. The system of claim 16, wherein clustering the set of the nodes sharing the common construct comprises utilizing perceptual hashing for each of the plurality of website constructs to identify the common construct for the grouping.

19. The system of claim 11, wherein the security module performs the security action that trains the GNN for identifying the unknown websites as potential scam websites based on the similarity score determined from the plurality of website constructs, by:
capturing structural information embedded in the graph to detect similarities between the unknown websites and the known scam websites; and
determining the similarity score based on the detected similarities.

20. A non-transitory computer-readable medium comprising one or more computer-executable instructions that, when executed by at least one processor of a computing device, cause the computing device to:
create a dataset of target websites comprising unknown websites and known scam websites with corresponding scam categories;
extract a plurality of website constructs utilized for executing scam attacks from the dataset of target websites;
build a graph comprising a plurality of nodes for associating each of the target websites with one or more of the corresponding scam categories;
group, for each of the nodes, the target websites based on sharing a common construct within the plurality of website constructs; and
perform a security action that trains a graph neural network (GNN) for identifying the unknown websites as potential scam websites based on a similarity score determined from the plurality of website constructs.
